(19) United States
(12) Patent Application Publication
(10) Pub. No.: US 2005/0015529 A1
(43) Pub. Date: Jan. 20, 2005

(54) Duplexing system and method using serial-parallel bus matching

(76) Inventors: Woo Sug Jung, Daejeon-city (KR); Do Young Kim, Daijeo-city (KR)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/892,790

(22) Filed: Jul. 15, 2004

(30) Foreign Application Priority Data
Jul. 16, 2003 (KR) 2003-48663

(51) Int. Cl. G06F 13/12

(52) U.S. Cl. 710/71

(57) ABSTRACT

A simultaneous write duplexing system with a fault-tolerant function and a method therefore are described. A serial-parallel converter is located between serial buses and parallel buses, and converts parallel data received from the parallel buses into serial data including unit identification information of a data destination. A buffer unit stores serial data received from the serial-parallel converter. A scheduler decides an output order of serial data stored in the buffer unit. A switching unit outputs serial data output from the buffer unit to a serial bus connected with a unit indicated by unit identification information of the serial data, according to the output order of the scheduler, and to a standby module for backing up system functions. Therefore, it is possible to connect an active module to a standby module spaced from the active module by several meters by allowing communication between the active module and the standby module.

This application claims the priority of Korean Patent Application No. 2003-48663, filed on Jul. 16, 2003, in the Korean Intellectual Property Office, the disclosure of which is incorporated herein in its entirety by reference.

### BACKGROUND OF THE INVENTION

1. Field of the Invention

The present invention relates to a duplexing system and method, and more particularly, to a simultaneous write duplexing system in which maintains consistency of memory data in both an active module and an standby module and has a fault-tolerant function by transmitting minimal data in a minimal time, and a method therefor.

2. Description of the Related Art

A fault-tolerant system operates in a predetermined order regardless of hardware failure or software errors. The fault-tolerant system generally includes a standby module for backing up system functions when a malfunction occurs, and is implemented differently according to the number and types of additional standby modules.

An exchange system can be repaired by an operator anytime when a malfunction occurs, and therefore does not need such many hardware standby modules as in medical equipment, a flight control system, satellites, an arms system, etc. Generally, an exchange system consists of a module for performing system functions and a standby module for backing up the system functions. This system configuration of the exchange system is called a duplexing scheme. A TDX requires high reliability and availability and supports a fault-tolerant function according to the duplexing scheme.

The duplexing method uses a simultaneous write method in order to maintain memory data stored in a standby module as it is in an active module. The simultaneous write method is a fault-tolerant method in which a write operation performed by an active module activates a write operation of a standby module so as to maintain consistency of memory data, and the standby module performs corresponding system functions of the active module if an error occurs in the active module so as to continue a service regardless of the error. A conventional simultaneous write duplexing system is disclosed in Korean Patent Publication No. 1997-069476 entitled “simultaneous write duplexer by memory bus extension in tight coupling defect permission system”. The conventional simultaneous write duplexing system uses a method which extends local buses of a processor or memory buses between a memory and a memory controller.

However, as the processor clock has recently extended up to several GHz, the bus clock has increased up to hundreds of MHz for enhancing bus performance. However, since the local buses and memory buses are parallel synchronous buses which operate in synchronization with the bus clock, the local buses and memory buses limit the signal transmission distance due to signal integrity, etc. according to the increase of the bus clock. Therefore, it is difficult to apply the conventional simultaneous write duplexing system to a present high-performance processor using several GHz.

### SUMMARY OF THE INVENTION

The present invention provides a simultaneous write duplexing system, which solves problems of a conventional simultaneous write system by extending parallel buses in correspondence to increase of a processor clock and bus clock, and has a fault-tolerant function by transmitting minimal data in a minimal time, and a simultaneous write duplexing method therefor.

The present invention also provides a computer-readable medium having embodied thereon a computer program for executing a simultaneous write duplexing method, which solves problems of a conventional simultaneous write system by extending parallel buses in correspondence to increase of a processor clock and bus clock, and has a fault-tolerant function by transmitting minimal data in a minimal time.

According to an aspect of the present invention, there is provided a duplexing system using serial-parallel bus matching comprising: a serial-parallel converter, which is located between serial bus and parallel bus of a processor, an input/output unit and a main memory, converts parallel data received from the parallel bus to serial data including unit identification information of a data destination, and outputs the serial data to the serial bus; a buffer unit, which stores the serial data received from the serial-parallel converter; a scheduler, which decides an output order of the serial data stored in the buffer unit; and a switching unit, which outputs the serial data output from the buffer unit to a serial bus connected to a unit indicated by the unit identification information of the serial data and to a standby module for backing up system functions, according to the output order of the scheduler.

According to another aspect of the present invention, there is provided a duplexing method using serial-parallel bus matching, comprising: (a) converting parallel data received from parallel buses of a processor, an input/output unit and a main memory into serial data including unit identification information of a data destination, and outputting the serial data to serial buses; (b) storing the serial data output to the serial buses; (c) deciding an output order of the stored serial data; and (d) outputting the stored serial data to a serial bus connected to a unit indicated by unit identification information of the serial data and to a standby module for backing up system functions.

### BRIEF DESCRIPTION OF THE DRAWINGS

The above and other features and advantages of the present invention will become more apparent by describing in detail exemplary embodiments thereof with reference to the attached drawings in which:

FIG. 1 is a block diagram of a duplexing system using serial-parallel bus matching, according to an embodiment of the present invention;

FIG. 2 shows a structure of serial data according to the present invention;

FIGS. 3a and 3b are block diagrams showing configurations of a serial-parallel converter according to the present invention;

FIGS. 4a and 4b are block diagrams showing configurations of a serial-parallel switching unit according to the present invention;

FIGS. 5a and 5b are views for explaining a scheduling method using a scheduler according to the present invention;

FIGS. 6a and 6b are views for explaining a data transmission method according to the present invention; and

FIG. 7 is a flowchart illustrating a duplexing method using serial-parallel bus matching, according to an embodiment of the present invention.

### DETAILED DESCRIPTION OF THE INVENTION

Hereinafter, embodiments of the present invention will be described in detail with reference to the appended drawings.

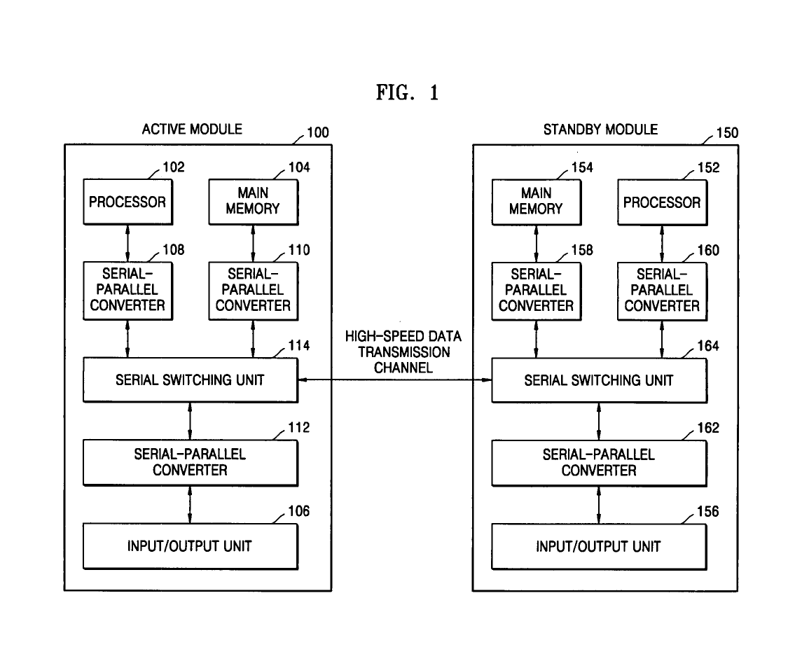

FIG. 1 is a block diagram of a simultaneous write duplexing system using serial-parallel bus matching, according to an embodiment of the present invention.

Referring to FIG. 1, the simultaneous write duplexing system consists of an active module 100 and a standby module 150. The respective active module 100 and standby module 150 include processors 102 and 152, main memories 104 and 154, input/output units 106 and 156, serial-parallel converters 108, 110, 112, and 158, 160, 162, serial switches 114 and 164, and module switching units (not shown), respectively.

The processors 102 and 152, the main memories 104 and 154, and input/output units 106 and 156 are basic components of a general duplexing system, and therefore other components can further be included in the system according to a type of the system.

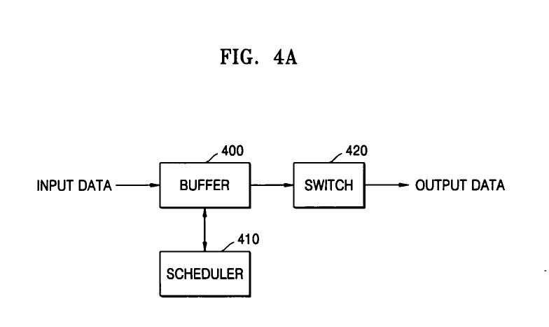

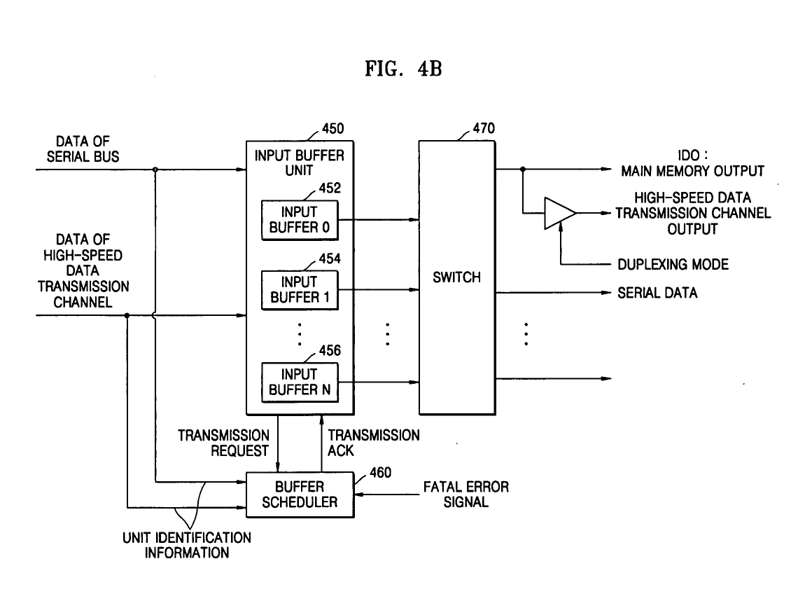

The serial-parallel converters 108, 110 and 112 connect a serial bus and a parallel bus of the processor 102, the main memory 104 and the input/output unit 106, convert parallel data received from the parallel bus into serial data 200 including unit identification information 202 to output the serial data 200 to the serial bus, and convert serial data 200 received from the serial bus into parallel data to output the parallel data to the parallel bus. To perform these operations, a Low Voltage Differential Signaling (LVDS) method, can be used. Use of the LVDS method extends the signal transmission distance to several meters. The serial-parallel converters 108, 110 and 112 will be described in more detail with reference to FIG. 4, as follows.

The serial switch 114 outputs serial data 200 received from the serial-parallel converters 108, 110 and 112 to corresponding units on the basis of unit identification information 202 of the serial data 200. That is, the serial switch 114 outputs the serial data 200 to a serial bus connected to a destination indicated by the unit identification information 202. If the unit identification information 202 of the serial data 200 indicates the main memory 104, the serial switch 114 outputs the serial data 200 to the serial switch 164 of the standby module 150 for backing up system functions. The serial switch 164 of the standby module 150 outputs the received serial data 200 to the main memory 152 of the standby module 150. The unit identification information 202 of the serial data 200 may be a logic value allocated by the processor 102 or a unique value physically allocated to each of units of the system.

Hereinafter, a simultaneous write method according to the present invention will be described. When a processor 102 of an active module 100 that performs a system function at present writes specific data into a main memory 104, a serial-parallel converter 108 connected to the processor 102 converts parallel data output from the processor 102 into serial data including unit identification information of the main memory 104. A serial switch 114 of the active module 100 outputs the serial data to a serial switch 164 of a standby module 150 as well as outputs the serial data to the main memory 104 using the unit identification information of the serial data. The serial switch 164 of the standby module 150 outputs the serial data to a serial-parallel converter 158 connected to the main memory 154 of the standby module 150 using the unit identification information of the serial data. The serial-parallel converter 158 converts the received serial data into parallel data and outputs the parallel data to the main memory 154. A serial switch 114 of the active module 100 and the serial switch 164 of the standby module 150 communicate with each other through a high-speed data transmission channel for simultaneous writing.

In order to maximize data throughput when transmitting data from a source unit to a destination unit in a simultaneous write duplexing system with a fault-tolerant function according to the present invention, an Overlaid data transmission method is used. The overlaid data transmission method will be described in detail later with reference to FIG. 6b.

The module switching unit (not shown) performs a switching operation and activates the standby module 150 when the active module 100 cannot operate normally due to generation of fatal errors so that the standby module 150 can perform a corresponding system function of the active module 100. If the module switching unit performs the switching operation, the processor 102 outputs data therein. The serial-parallel converter 108 connected with the processor 102 converts parallel data output from the processor 102 into serial data 200 including unit identification information 202 indicating the main memory 104. The serial switch 114 outputs the serial data 200 to the main memory 104 and to the serial switch 164 of the standby module 150. The serial switch 164 of the standby module 150 outputs the serial data 200 to the main memory 154 of the standby module 150. Accordingly, all data existed in the active module before generation of a fatal error can be simultaneously written into the standby module 150.

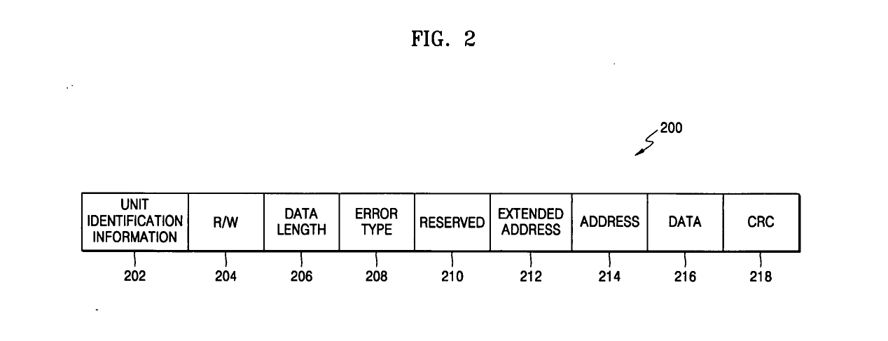

FIG. 2 shows a structure of the serial data including the unit identification information, according to the present invention.

Referring to FIG. 2, the serial data 200 according to the present invention includes a unit identification information field 202, a read/write (R/W) information field 204, a data length information field 206, an error type information field 208, a reversed field 210, an extended address field 212, an address field 214, a data field 216, and a CRC field 218.

Unit identification information 202 may be a unit identifier logically allocated to each of units, or a unique value physically allocated to each of the units. The unit identification information is set according to an address map regarding addresses of the respective units in the system. The address map is an address area allocated for transmitting data to its corresponding unit.

For example, if 0000H-1FFFH are allocated to ROM, 2000H-3FFFH are allocated to RAM, and F000H-FFFFH are allocated as input/output addresses for data communication, the serial-parallel converters 108, 110 and 112 convert parallel data with an address between 0000H and 1FFFH into serial data 200 including unit identification information of ROM, and convert parallel data with an address between 2000H and 3FFFH into serial data 200 including unit identification information 202 of RAM.

The read/write information field 204 indicates whether a corresponding frame is read or written, and the data length information field 206 indicates an entire length of data. The error type information field 208 is to record error information therein when an error is generated in a certain unit while a data frame is processed. Error information recorded in an error type information field 208 of serial data 200 is returned to a source unit with an address 214 of the serial data 200. Here, units, which transmit or receive the information, communicate to each other using a full-duplex communication method.

The reserved field 210 may be used to additionally extend addresses. The extended address field 212 is used to process data with an address longer than a basic address.

The address field 214 is an address area allocated for transmitting data to a unit. The data field 216 stores data received through parallel buses. The CRC field 218 is used to allow a destination unit to check whether an error is generated while a data frame is transmitted. If the destination unit detects an error through the CRC field 218, CRC error information is recorded in the error type information field 208.

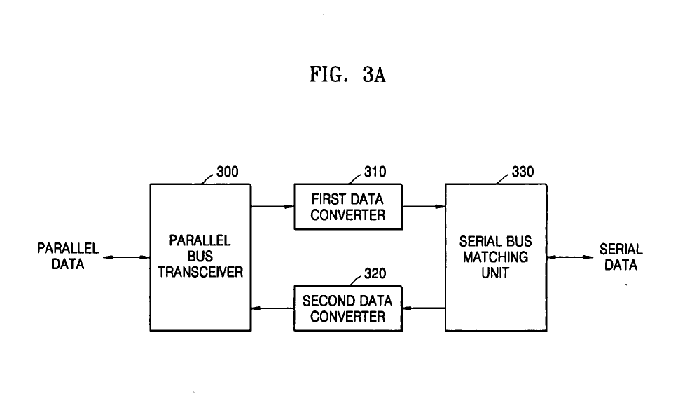

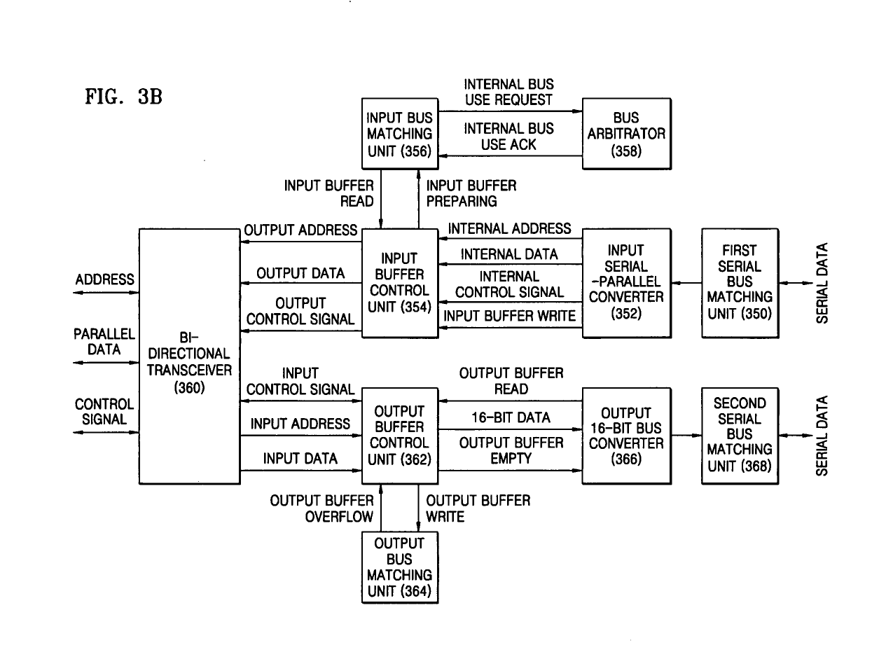

FIG. 3a is a block diagram of the serial-parallel converter according to the present invention.

Referring to FIG. 3a, the serial-parallel converter includes a parallel bus transceiver 300, a first data converter 310, a second data converter 320, and a serial bus matching unit 330.

The parallel bus transceiver 300 is connected with parallel buses and receives or transmits parallel data. The parallel bus transceiver 300 supports the full-duplex communication method. The first data converter 310 converts parallel data received from the parallel bus transceiver 300 into serial data 200 including destination unit identification information. The second data converter 320 converts serial data 200 received from the serial bus matching unit 330 into parallel data. The serial bus matching unit 330 is connected with serial buses and receives or transmits serial data. The serial bus matching unit 330 also supports the full-duplex communication method.

FIG. 3b is a detailed block diagram of the serial-parallel converter according to the present invention;

Referring to FIG. 3b, the serial-parallel converter includes a first serial bus matching unit 350, an input serial-parallel converter 352, an input buffer controller 354, an input bus matching unit 356, a bus arbitrator 358 and a bi-directional transceiver 360, as components for converting data for a serial bus into data for a parallel bus, and includes an output buffer controller 362, an output bus matching unit 364, an output 16-bit bus converter 366 and a second serial bus matching unit 368, as components for converting data for a parallel bus into data for a serial bus.

First, components for converting the data for the serial bus into the data for the parallel bus are described.

The first serial bus matching unit 350 is connected with serial buses, and includes a PLL for generating a recovery clock based on data received through the serial buses, a unit for converting a differential signal such as LVDS into a single-ended signal, and a unit for transmitting data received from the serial bus to the input serial-parallel converter 352 in synchronization with a serial clock received from the PLL. If a conventional clock is used to the serial bus, signal integrity cannot be ensured. Accordingly, the present invention applies a recovery clocking method used in a time division module (TDM) method to the serial bus, instead of a general clocking method.

The bidirectional transceiver 360 is connected with parallel buses and receives or transmits parallel data.

The input serial-parallel converter 352 converts data received from the first serial bus matching unit 350 into 16-bit data using internal shift registers. This is required because most commercial devices of physical layers for converting data for a serial bus into data for a parallel bus have 16 bit matching. Accordingly, the input serial-parallel converter 352 may be constructed to change data into different bit data rather than 16 bit data according to a structure of a commercial device.

The input serial-parallel converter 352 checks a CRC field of a received serial data, compares the CRC value of the received data with an internally calculated CRC value to detect an error, and outputs a corresponding signal regarding a disturbance (error) to an error processing unit (not shown). Then, the error processing unit informs the processor 102 of an error generation using an interrupt.

The input serial-parallel converter 352 activates an input buffer write signal, converts an address 214, data 216 and a control signal included in the serial data into an internal address, internal data and an internal control signal, and transmits the internal address, the internal data and the internal control signal to the input buffer controller 354. The transmitted data is stored in the input buffer controller 354.

If the input buffer controller 354 transmits an input buffer preparing signal to the input bus matching unit 356 if information corresponding to an operation of a parallel bus is stored in the input buffer controller 354.

The input bus matching unit 356 receives the input buffer preparing signal from the input buffer controller 354 and outputs an internal bus use request signal to the bus arbitrator 358 in order to obtain a parallel bus ownership. If the input bus matching unit 356 receives an internal bus use acknowledge signal from the bus arbitrator 358, the input bus matching unit 356 transmits the internal bus use acknowledge signal directly to the bidirectional transceiver 360. The internal bus use acknowledge signal is output to the parallel bus via the bi-directional transceiver 360. Then, the other units determine that the serial-parallel converters 108, 110 and 112 have the bus ownership and do no longer perform related operations on the parallel bus.

If the bus arbitrator 358 receives an external bus use request from an external unit and an internal bus use request from the input bus matching unit, the bus arbitrator 358 allocates a bus ownership to respective units appropriately according to an internal arbitration algorithm on the basis of activation/non-activation of an external bus use signal. The bus arbitrator 358 makes reference to the external bus use signal because two bus masters must not exist simultaneously on the parallel bus.

Next, components for converting data for a parallel bus into data for a serial bus are described.

The output buffer controller 362 stores information received from the parallel buses, that is, addresses, data, and control signals.

The output bus matching unit 364 creates and transmits a response signal in correspondence to an address and data transferred through the parallel bus, thereby informing a parallel bus master unit of whether or not the operation of the parallel bus is normally terminated. Also, the output bus matching unit 364 creates an output buffer write signal for storing an input address, input data and a related input control signal received from the parallel bus in the output buffer controller 362. At this time, if the output bus matching unit 362 receives an output buffer full signal indicating that information can be stored no longer from the output buffer controller 362, the output bus matching unit 364 transmits a signal related to an error generation to the parallel buses in order to inform the parallel master unit of a fact that information received from the parallel bus is not stored correctly in buffers.

The output buffer controller 362 outputs an output buffer empty signal to the output 16-bit bus converter 366, thereby informing an output 16 bit bus converter 366 of a fact that information related to the internal buffer is stored.

If the output 16-bit bus converter 366 receives an output buffer empty signal from the output buffer controller 362, the output 16-bit bus converter 366 outputs an output buffer read signal to the output buffer controller and reads corresponding information from the output buffer controller 362 per each 16-bits. Here, since the output buffer controller 362 processes data at a 64 bit rate, the output 16-bit bus converter 366 creates a quadruple clock of a bus clock using a PLL (not shown) to read related information. If the output 16-bit bus converter 366 uses the same clock as the bus clock, a generation probability of the output buffer full signal becomes higher since a speed at which the output 16 bit bus converter reads data from the output buffer controller 362 is relatively slower than a speed at which information received from the parallel bus is stored in the output buffer controller 362, which may occur serious performance deterioration. Setting a data width of the output 16-bit bus converter 366 into 16 bits is because the bus width used in a general SERDES (Serial to Deserialize) unit is 16 bits.

If the output 16-bit bus converter 366 receives information related to one bus operation from the output buffer controller 362, the second serial bus matching unit 368 converts the information to serial data and outputs the serial data to the serial bus in synchronization with a serial clock which is a clock signal of the serial bus.

Each component shown in FIG. 3b uses an overlaid data transmission method which divides operations according to functions. In order to obtain maximal performance of the serial-parallel converter, the serial-parallel converter uses a full-duplex communication method in which a conversion from serial bus to parallel bus is performed separately from a conversion from parallel buses to the serial bus. The overlaid data transmission method is described in detail with reference to FIG. 6b.

FIGS. 4a is a block diagram of the serial-parallel switching unit according to the present invention.

Referring to FIG. 4a, the serial-parallel switching unit includes a buffer unit 400, a scheduler 410 and a switch 420.

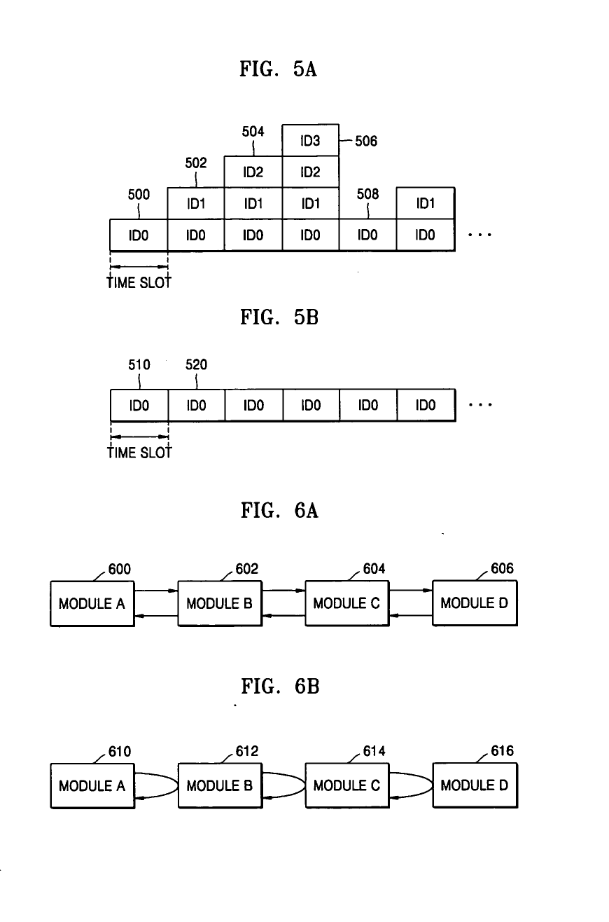

The buffer unit 400 stores serial data 200 transmitted through a serial bus. The scheduler 410 decides an output order of the serial data 200 stored in the buffer unit 400. A method in which the scheduler 410 decides the output order is described with reference to FIGS. 5a and 5b. If the scheduler 410 receives a transmission request signal from the buffer unit 400, the scheduler 410 decides an output order and outputs a transmission acknowledge signal to the buffer unit 400 according to the output order. The buffer unit 400 outputs the serial data of the buffer unit 400 to the switch 420 in response to the transmission acknowledge signal.

The switch 420 outputs the serial data 200 output from the buffer unit 400 to a serial bus connected to a unit indicated by unit identification information 202 of the serial data 200. If the unit identification information 202 of the serial data 200 indicates the main memory 104, the switch 420 outputs the serial data 200 to the serial switch 164 of the standby module 150 for backing up system functions.

Also, the buffer unit 400 stores serial data received via input ports and serial data received through a high-speed data channel in corresponding buffers. At this time, IDs of the serial data are stored simultaneously in the internal buffers of the scheduler. Then, the buffers send a transmission request signal to the scheduler in order to transmit the serial data to the switch. The scheduler received the transmission request signal operates in a PAR mode of a general schedule mode and operates in a PO mode for quickly performing a switching operation when receiving from the error processing unit a fatal error generated when no system function can be performed. The PAR and PO modes will be described in detail with reference to FIGS. 5a and 5b.

FIG. 4b is a block diagram of the serial-parallel switching unit according to the present invention.

Referring to FIG. 4b, the serial-parallel switching unit includes an input buffer unit 450, a buffer scheduler 460 and a switch 470.

The input buffer unit 450 has a structure which allocates respective buffers 452, 454 and 456 to the respective serial-parallel converters 108, 110 and 112. The input buffer unit 450 stores serial data received from the serial bus and serial data received through a high-speed data transmission channel connecting the active module and the standby module, in a corresponding buffer. When the serial data is stored in the input buffer unit 450, unit identification information corresponding to a destination of the serial data is stored in the buffer scheduler 460.

If the serial data is stored in the input buffer unit 450, the input buffer unit 450 activates and sends a transmission request signal to the buffer scheduler 460 in order to perceive an output order for transmitting the serial data to the switch 470. Each of N input buffers 452, 454, and 456 of the input buffer unit 450 activates and sends a transmission request signal to the buffer scheduler 460 when data is stored therein.

If the buffer scheduler 460 receives the transmission request signal, the buffer scheduler 460 operates in a PAR (Priority and Round Robin) mode of a general schedule mode. If the buffer scheduler 460 receives a fatal error signal generated when a corresponding system function is not performed, from the error processing unit (not shown), the buffer scheduler 460 operates in a PO mode in order to quickly perform a switching operation. The PAR and PO modes will be described in detail with reference to FIGS. 5a and 5b.

After the buffer scheduler 460 performs scheduling by a scheduling algorithm according to a duplexing operation mode, the buffer scheduler 460 sends a transmission acknowledge signal allowing transmission of serial data of a corresponding input buffer to the input buffer unit 450. If the input buffer unit 450 receives the transmission acknowledge signal, the input buffer unit 450 outputs the serial data stored in the corresponding buffer to the switch 470.

The switch 470 outputs the serial data received from the input buffer unit 460 to a serial bus connected to a destination of the serial data. The switch 470 outputs the serial data to the standby module through the high-speed data transmission channel connecting the active module and the standby module as well as to the main memory if the destination of the serial data is the main memory, that is, ID0, in order to implement a simultaneous write duplexing function. The standby module outputs the received serial data to its main memory. Accordingly, the main memories of the active module and the standby module can always maintain data consistency. The switching unit according to the present invention can easily implement a duplexing system by controlling a high speed data transmission channel output through one output port according to a duplexing mode. If the switching unit is a switching unit of a standby module or is not operated according to the duplexing mode, the switching unit outputs no high-speed data transmission channel, thereby not influencing to the active module or neighboring modules. The switching unit has N*N ports wherein N represents the number of input and output ports.

FIGS. 5a and 5b are views for explaining a scheduling method using a scheduler according to the present invention.

FIG. 5a shows a PAR method. Referring to FIG. 5a, there are provided four serial data whose unit identification information 202 are ID0 500, ID1 502, ID2 504 and ID3 506. The scheduler 410 allocates a highest priority to a unit with a maximum amount of data transmission and allocates a lowest priority to a unit with a minimum amount of data transmission. In FIG. 5a, if the ID0 500 has the highest priority, ID1 502, ID2 504 and ID3 506 have sequential priorities in this order. Here, ID represents an identifier of a destination unit.

The scheduler 410 selects serial data 200 with a highest priority as an object to be scheduled. Accordingly, in a first time slot, ID0 is first scheduled. The scheduler 410 outputs a transmission acknowledge signal to the buffer unit 400 if receiving a transmission request signal for ID0 500 from the buffer unit 400, and the buffer unit 400 received the transmission acknowledge signal outputs the ID0 500 to the switch 420. If no transmission request signal is received, the scheduler 400 selects a new object to be scheduled.

In the following time slot (referred to as second time slot), the scheduler 400 selects ID1 502 with a priority lower than ID0 500, as an object to be scheduled. If receiving a transmission request signal for ID1 502 from the buffer unit 400, the scheduler 400 outputs a transmission acknowledge signal for ID1 502 to the buffer unit 400, and simultaneously, the scheduler 400 determines whether a transmission request signal for ID0 500 is received and outputs a transmission acknowledge signal for ID0 500 to the buffer unit 400 if the transmission request signal is received. That is, the ID0 500 and ID1 502 depend on a round robin method in their output order. As a result, by performing a scheduling for ID0 in the first time slot and performing schedulings for ID0 and ID1 in the second time slot, the ID1 can be scheduled in at least one among the two time slots, thereby achieving fairness between ID0 and ID1.

After scheduling the ID0 and ID1, the scheduler 410 selects ID2 504 with a priority lower than the ID1 502, as an object to be scheduled, additionally to the ID0 500 and ID1 502. After performing schedulings for all units in such a manner, the scheduler 410 selects ID0 508 with a highest priority as an object to be scheduled. Therefore, since each of the units has at least one output turn according to the PAR method, starvation does not occur.

FIG. 5b is a view for explaining a method of deciding an output order according to a PO (Priority Only) method.

Referring to FIG. 5b, the scheduler 410 outputs only data for serial data ID0 510 of a unit with a highest priority. In this case, starvation for a unit with a priority lower than the ID0 may occur. However, since fast data transmission is needed when switching from the active module 100 to the standby module 150 is performed, the output order is decided according to the PO method. Except for when switching between the active module 100 to the standby module 150 is performed, the output order is decided according to the PAR method.

FIGS. 6a and 6b are views for explaining a data transmission method according to the present invention.

FIG. 6a shows a Non-overlaid data transmission method. Referring to FIG. 6a, a module A 600 transfers data to a module B 602, the module B 602 transfers the received data to a module C 604, and the module C 604 transfers the data to a module D 606. If the module D 606, which is a destination module, receives normal data, the module D 606 transfers a receipt acknowledge message to the module A 600 through the module C 604 and module B 602. The module A received the receipt acknowledge message performs a predetermined operation.

FIG. 6b shows an Overlaid data transmission method. Referring to FIG. 6b, the module A 610 transfers data to the module B 612, and the module B 612 received the data transmits a receipt acknowledge message to the module A 610. The module A 610 receives the receipt acknowledge message and performs a predetermined operation. The module B 612 transfers data to a module C 614. If receiving a receipt acknowledge message from the module C 614, the module B 612 performs a predetermined operation. In such a manner, data is transferred from the module A 610 to a module D 616 being a destination module.

While data is transmitted, if a certain module is not operated normally due to generation of hardware failure and software errors, etc., the generated error information is recorded on an error type information field 208 of serial data 200 and is returned to a source module with an address 214 of the serial data 200. The type and location of the generated error can be perceived by the error information 208 recorded in the error type information field and the address 214.

The respective modules shown in FIGS. 6a and 6b may be the serial-parallel converters 108, 110, 112, 158, 160 and 162 and the serial switching units 114 and 164 as described above. Each of the modules supports the full-duplex communication method.

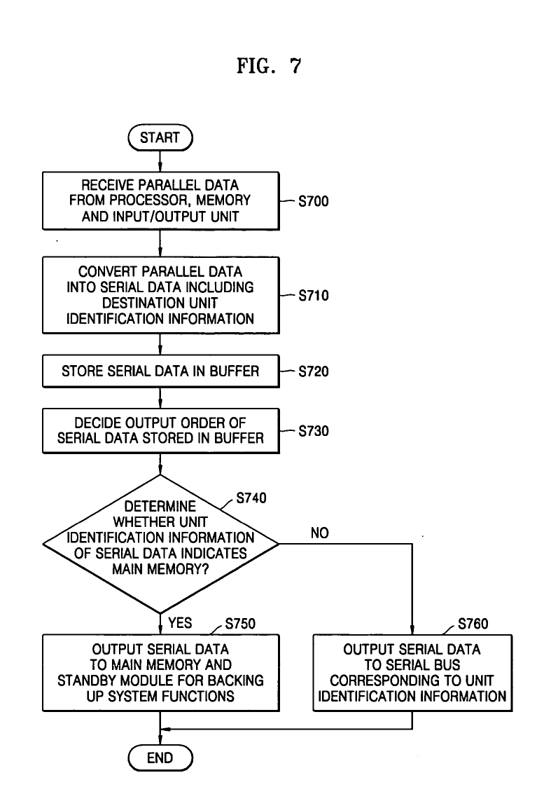

FIG. 7 is a flowchart illustrating a simultaneous write duplexing method with a fault-tolerant function, according to the present invention.

Referring to FIG. 7, a serial-parallel converter 108 receives parallel data from a processor 102, a main memory 104 and an input/output unit 106 in step S700, and converts the received parallel data into serial data 200 including destination unit identification information 202 in step S710.

The buffer unit 400 stores serial data 200 converted by the serial-parallel converters 108, 110 and 112 and output through the serial bus, in step S720. The serial data 200 is stored in the buffer unit 400 according to the unit identification information 202 of the serial data. The scheduler 410 decides an output order of the serial data 200 stored in the buffer unit 400 according to the PAR method illustrated in FIG. 5a, in step S730. The scheduler 410 can decide the output order according to a different method from the PAR method.

If the unit identification information 202 of the serial data 200 indicates the main memory 104 in step S740, the switching unit 420 outputs the serial data 200 to serial buses to which the main memory 104 is connected and to a serial switching unit 164 of a standby module 150 for backing up system functions in step S750. The serial switching unit 164 of the standby module 150 received the serial data 200 outputs the serial data 200 to the main memory 154 of the standby module 150. Therefore, a simultaneous write method with a fault-tolerant function is implemented.

Also, if the unit identification information 202 of the serial data does not indicate the main memory 104 in step S740, the switching unit 420 outputs the serial data 200 to a serial bus to which a unit indicted by the unit identification information 202 of the serial data is connected, in step S760.

If an active module 100 cannot be normally operated due to a fatal error, switching from the active module 100 to the standby module 150 is performed and accordingly the standby module is activated to perform a corresponding system operation. When switching from the active module 100 to the standby module 150 is performed, the processor 102 outputs data therein. The serial-parallel converter 108 connected to the processor 102 converts parallel data received from the processor 102 into serial data 200 including the unit identification information 202 indicating the main memory 104. The serial switching unit 114 outputs serial data 200 to the serial switching unit 164 of the standby module 150 and the main memory 104. The serial switching unit 164 of the standby module 150 outputs the serial data to the main memory 154 of the standby module 150. Therefore, all data existed in the active module before the generation of the fatal error are simultaneously written into the standby module 150.

The present invention may be embodied as a program stored on a computer readable medium that can be run on a general computer. Here, the computer readable medium includes but is not limited to storage media such as magnetic storage media (e.g., ROM's, floppy disks, hard disks, etc.), optically readable media (e.g., CD-ROMs, DVDs, etc.), and carrier waves (e.g., transmission over the Internet). The present invention may also be embodied as a computer readable program code unit stored on a computer readable medium, for causing a number of computer systems connected via a network to affect distributed processing.

As described above, according to the present invention, it is possible to connect an active module to a standby module spaced from the active module by several meters by allowing communication between the active module and the standby module through a serial high-speed data transmission channel. Accordingly, the present invention is applicable to a high-performance microprocessor running at hundreds of MHz. Also, when switching from the active module to the standby module is performed, a data output order is decided according to a PO method, thereby minimizing the time taken for the switching.

While the present invention has been particularly shown and described with reference to exemplary embodiments thereof, it will be understood by those of ordinary skill in the art that various changes in form and details may be made therein without departing from the spirit and scope of the present invention as defined by the following claims.

1. A duplexing system using serial-parallel bus matching comprising:
a serial-parallel converter, which is located between serial bus and parallel bus of a processor, an input/output unit and a main memory, converts parallel data received from the parallel bus to serial data including unit identification information of a data destination, and outputs the serial data to the serial bus;
a buffer unit, which stores the serial data received from the serial-parallel converter;
a scheduler, which decides an output order of the serial data stored in the buffer unit; and
a switching unit, which outputs the serial data output from the buffer unit to a serial bus connected to a unit indicated by the unit identification information of the serial data and to a standby module for backing up system functions, according to the output order of the scheduler.

2. The duplexing system of claim 1, wherein the switching unit outputs the serial data to the standby module if the unit identification information of the serial data indicates the main memory.

3. The duplexing system of claim 1, further comprising a module switching unit which switches from the standby module to an active module if an error is generated,
wherein the processor outputs data therein when the module switching unit switches from the standby module to the active module, and the serial-parallel converter converts parallel data output from the processor into serial data including unit identification information of the main memory.

4. The duplexing system of claim 3, wherein the scheduler includes a priority provider, which allocates a priority to the unit indicated by the unit identification information of the serial data according to an amount of data transmission when the module switching unit switches from the standby module to the active module.

5. The duplexing system of claim 1, wherein the scheduler comprises:
a priority provider, which provides a priority to the processor and the unit indicated by the unit identification information of the serial data according to an amount of data transmission; and
an output order decision unit, which divides all units into N groups in a manner to classify all the units sequentially from a first group with a highest priority to a N-th group with a lowest priority on the basis of the priority, and decides an output order for units in each group according to a Round-Robin method.

6. The duplexing system of claim 1, wherein the serial data includes an error type field which includes information indicating error types and an address field which includes information indicating addresses of units, and
the serial-parallel converter, the buffer unit, the scheduler and the switch unit record an error in the error type field if the error is generated in received serial data, and return the serial data to a source unit of the serial data with an address of the serial data.

7. The duplexing system of claim 1, wherein the serial-parallel converter comprises:
a bidirectional transceiver, which is connected to the parallel buses and receives or transmits the parallel data;
a serial bus matching unit, which is connected to the serial buses and receives or transmits the serial data; and
a data converter, which converts parallel data received from the bi-directional transceiver into serial data including unit identification information of a data destination location to output the serial data to the serial bus matching unit, and converts serial data received from the serial bus matching unit into parallel data to output the parallel data to the bi-directional transceiver.

8. A duplexing method using serial-parallel bus matching, comprising:
(a) converting parallel data received from parallel buses of a processor, an input/output unit and a main memory into serial data including unit identification information of a data destination, and outputting the serial data to serial buses;
(b) storing the serial data output to the serial buses;
(c) deciding an output order of the stored serial data; and
(d) outputting the stored serial data to a serial bus connected to a unit indicated by unit identification information of the serial data and to a standby module for backing up system functions.

9. The duplexing method of claim 8, wherein step (d) is to output the serial data to the standby module if the unit identification information of the serial data indicates the main memory.

10. The duplexing method of claim 8, wherein step (c) comprises:
(e) providing a priority to a unit indicated by the unit identification information of the serial data according to an amount of data transmission; and
(f) deciding an output order on the basis of the priority.

11. The duplexing method of claim 8, wherein step (c) comprises:
(g) providing a priority to a unit indicated by the unit identification information of the serial data according to an amount of data transmission; and
(h) dividing all units into N groups in a manner to classify all the units sequentially from a first group with a highest priority to a N-th group with a lowest priority on the basis of the priority, and deciding an output order for units in each group according to a Round-Robin method.

12. The duplexing method of claim 8, wherein the serial data includes an error type field which includes information indicating error types and an address field which includes information indicating addresses of units, and
in steps (a) through (d), if a predetermined error is generated when received serial data is processed, the serial data is returned to its source unit with an address of the serial data after the generated error is recorded in the error type field of the serial data.

13. A computer-readable medium having embodied thereon a computer program for executing a duplexing method using serial-parallel bus matching, comprising:
(a) converting parallel data received from parallel buses of a processor, an input/output unit and a main memory into serial data including unit identification information of a data destination, and outputting the serial data to serial buses;
(b) storing the serial data output to the serial buses;
(c) deciding an output order of the stored serial data; and
(d) outputting the stored serial data to a serial bus connected to a unit indicated by unit identification information of the serial data and to a standby module for backing up system functions.
